(19) United States
(12) Patent Application Publication
(10) Pub. No.: US 2009/0094100 A1
(43) Pub. Date: Apr. 9, 2009

(54) COMPLETE SELF-CHECKOUT SYSTEM FOR RETAIL STORES USING WIRELESS ENABLED HANDHELD DEVICES

(76) Inventor: JIJO MUKKATH XAVIER, SUNNYVALE, CA (US)

Correspondence Address: JIJO MUKKATH XAVIER, 61 RAIN WALK, MILPITAS, CA, 95035, US

(21) Appl. No.: 12/284,063

(22) Filed: Dec. 29, 2006

Related U.S. Application Data
(60) Provisional application No. 60/766,224, filed on Jan. 2, 2006.

(51) Int. Cl. G06Q 30/00; G06Q 20/00

(52) U.S. Cl. 705/10; 705/14; 705/21; 705/17

(57) ABSTRACT

A novel system EzCheckout using wireless enabled hand held devices is disclosed. This system enables an all-new way of complete end to end shopping. The customer enters the code of the item he needs, does price check, does the checkout process and payment all by himself without interacting with any shopkeepers (unless he/she is buying some restricted items like alcohol). EzCheckout system is based on the wireless connectivity of hand-held devices like cell-phones and PDA's. EzCheckout is a simple but effective way of helping users to make their shopping fast and easy using the power of networking capability of handheld devices. This makes the customer shopping experience interesting and satisfying. This also provides a number of advantages to the store in terms of satisfied customers with lower cost of operation, capability for personalized individual marketing and reduced liability.

### PRIORITY

The application claims priority of the provisional application on file at the Patent office having the application No. 60/766,224, filed on Jan. 2, 2006.

### FIELD OF INVENTION

The disclosure is of a system in the area of wireless and web usage for an all-new way of easy and complete end-to-end shopping.

### BACKGROUND OF INVENTION

One of the major problems that retail stores currently face is dealing with long lane of customers at the checkout counter. Self-checkout counters have been installed in many stores but they are also not efficient enough to service customers on time. Any delay caused by a customer at the counter incrementally affects all the rest of the customers standing in the queue. Currently there is no good solution for this problem. Another related problem is the security in payment transactions and personal security data collected by the stores. Customers are always worried about their personal identity information and credit card or bank account information being stolen.

Today almost all new cell phones and most of the PDAs are blue-tooth and/or wi-fi supported. JAVA and Internet browser are standard. New input/output options (like USB and 1394) are also being added. More and more network features are being added to every newly released model. This tells us that networking with handheld devices is inevitable.

### BRIEF DESCRIPTION OF DRAWINGS

FIG. 1: Is a system diagram of the EzCheckout system.

FIG. 2: Is a block diagram of the EzCheckout system

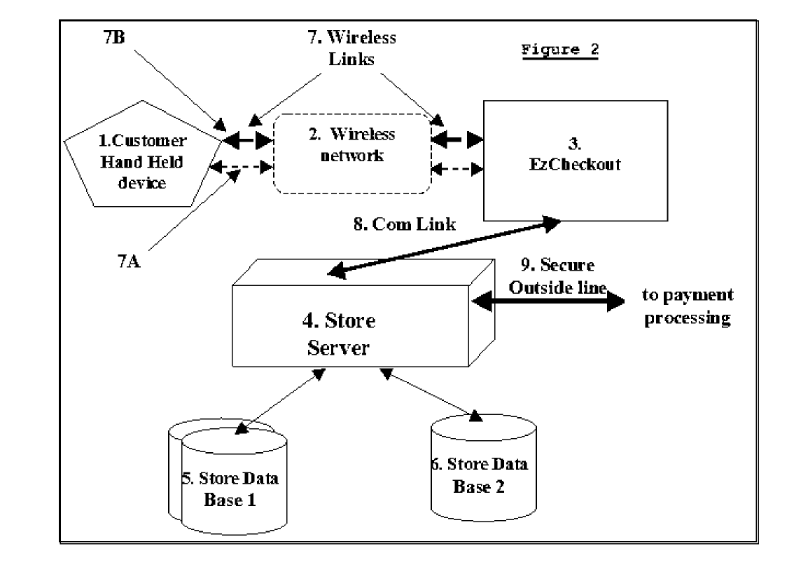

### EXPLANATION OF NUMBERING AND LETTERING IN FIGURES FOR TYPICAL IMPLEMENTATION OF THE TECHNOLOGY FIG. 2

Items and Numbering:

### 1. Customer Hand Held Device

### 2. Wireless Network

### 3. EzCheckout Server

### 4. Store Server

### 5. Store Data Base 1

### 6. Store Data Base 2

7. In store wireless links
8. Communication link between EzCheckout server and Store Server
9. Secure Outside line.

### OBJECTS AND ADVANTAGES OF THE CURRENT APPLICATION

The objects and advantages of the current disclosure are two types: A) Customer related and B) Store related.

Customer related objects and advantages are:
1. Provide a way improve the shopping experience of individuals by reducing the wait time in lines especially during high season for shopping.
2. Use the customer owned hand held-like cell phones and PDAs that are wireless enabled for shopping.
3. Provide a secure safe way to handle and store personal information and retain it under the customer control.
4. Reduce the chance of ID theft by reducing the period during which the data is temporarily stored under the store control.
5. Eliminate the need to have membership cards, credit cards, check or cash during shopping.
6. Make it possible to have access to sales information, coupons and discounts at time of purchase for decision making.

Store related objects and advantages are:
1. Provide saving in manpower needed at check out counters by use of self check out.
2. Each customer with a wireless enabled handheld becomes a check out line reducing the congestion in the store.
3. Reduce investment in store equipment and maintenance.
4. Save premium store space.
5. Enable individualized personal preference data collection.
6. Improve sales performance by individualized sales and point of sale coupons and promotions.
7. Improve store sales performance by elimination of unacceptable delays during high sales period
8. Reduce the liability of the store by eliminating storage of personal and secure payment data needed for transactions in house.

### DETAILED DESCRIPTION OF THE INVENTION

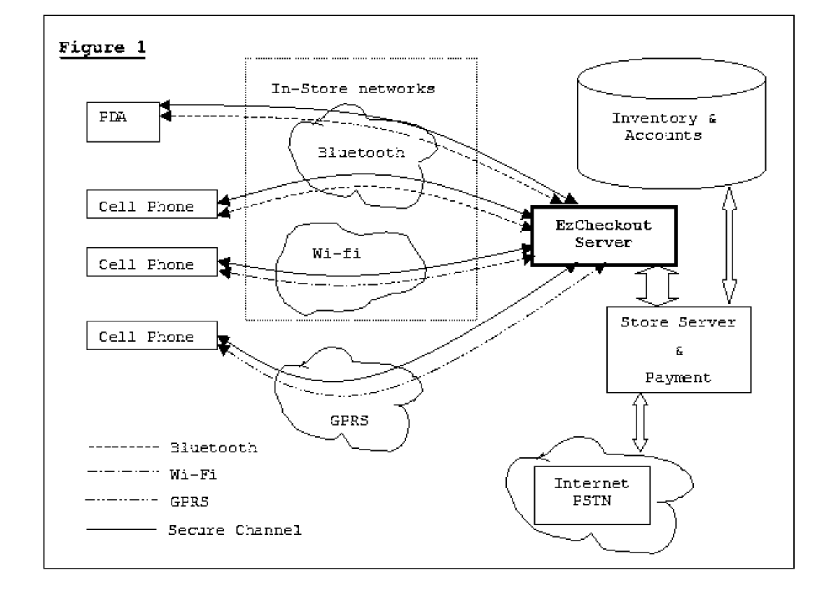

The embodiment of the invention is the “EzCheckout” system, shown in FIG. 1 a fast and efficient way of shopping. EzCheckout system block diagram FIG. 2 consists of a host server computer (3), also called host server, located in or outside the store, different from the store server computer (4) with data bases (5), (6) and payment tracking capability, and a wireless enabled handheld device (1), which the customer carries. The host computer (3) is owned and maintained by the retail store. The handheld device (1) is individually owned and can typically be a cell phone or a PDA (or combined), capable of communicating with the host computer over a standard wireless network (2) (blue-tooth, wi-fi or GPRS). The host computer (3) has secure access to the store's inventory/account database (5) through the com.link (8) to store computer (4). The client program running on the customer's hand held device (1) communicates with the host computer over a secure and reliable wireless Internet channel (7). The communication protocol between the host computer and the hand held device is standard and well known, so that the user can take his hand held device to any store.

The proposed EzCheckout system works as follows. As the customer walks into the store with his wireless enabled handheld device (1), typically a Cell Phone or a PDA, a client application running on the handheld enables connection to the host computer (3) over existing wireless media (2) in the store. Method of connection initiation can vary from media to media, which all of which well known and exist in the field today. Once the connection to the server computer (3) is established by the chosen protocol, the client application on the customer's hand held device (1) establishes a secure communication channel (7A) with the host computer. Once the secure communication channel has been established, the client user interface shows up on the customer's hand held device (1). Typically the UI would look very similar to a typical online shopping cart to take advantage of the customer's familiarity with the existing shopping cart configuration. Now the customer is ready to add items to this virtual shopping cart. A typical add-to-shopping-cart process works as follows. Customer picks the item he is interested in. If his hand held device (1) supports a bar-code reader or has a built in camera, he will scan (auto input) the bar code using the device. This can be by direct scanning or by taking a picture of the bar code. Otherwise he will enter the item code manually. Once the code item number has been entered, this is transmitted to the host computer (3) which decodes the bar code. The customer can then check the price and/or add the item to the shopping cart. Customer will repeat this process for every item he is interested in. The UI on the hand held device (1) displays the selected list of items, price of each item, total amount etc. similar to today's shopping carts used in internet purchasing. The customer also has the option to remove an item from his shopping cart. Once the customer is done with shopping, he clicks the “check out” button on the hand held device UI. This would trigger the checkout process. Checkout process involves submitting items in the shopping cart to the host computer along with coupons, and store loyalty numbers, The loyalty, personal information, debit card and/or credit card information can be stored in the handheld device (1) and can be retained in the consumers possession securely for immediate access at all times. The host computer will verify items and will send the total amount back to the hand held device. The client UI will display the payment screen with the information for the customer re-conform the payment information. Then the hand held will submit the customer's payment information to the server using a super secure channel (7B) with information regarding the credit card or debit card. The proposed method is to use the standard PKI based encryption. This ensures privacy and security. Payment can be done with credit cards or check card. The user doesn't have to enter the payment information every time. It will be stored securely, with encryption and password protection on the hand held device. The client program reads the information and uses it. Once the payment information is received, the server transfers it over to the store processor which processes it through standard channels and available connection to the out side (9) and credits the amount to the store's account.

EzCheckout system is divided into two program blocks 1) The client program (the client) and 2) the server program (the server). Functionality of each is explained below. Communication between client and server is assumed to be over a secured wireless network. Details of the network are not in the scope of this disclosure. EzCheckout client is designed with portability and security in mind. What this means is that the customer should be able to use any hand held device to access EzCheckoutsystem no matter what OS/platform is running on the hand held. The proposed method is to use JAVA, which is supported on almost all new PDA's and cell phones. As a first step, user will install and configure this client program. This includes 1) Downloading the client program from a well-known and well-advertise web site and running the installer. 2) Entering his name, address, password, credit card or bank account information, certificates etc. into the program for storage in the hand held in a secure manner. The client program installer will provide an easy-to-use UI for that. Once configured, the client is ready to use. Depending on the kind of wireless network support the handheld device has, the user has options to use Bluetooth, GPRS or Wi-fi. There are well understood methods available for server discovery and connection with each of these. Those are known to practitioners of the art and not in the scope or coverage of this disclosure. Once the client locates servers, it allows the user to pick the right server from a list, if more than one server is available tom service the client at the store. Once the user selects a server from the list of available servers, client program initiates a “test-connection” to the server. This test connection will be used to authenticate the server. Once the server is authenticated, the user can proceed to shopping.

It should be noted that the host server can be located in store or outside the store premises, with GPRS, where as with Bluetooth and Wi-fi implementation the host server has to be in the store premises to achieve connectivity. The GPRS implementation has the additional advantage that a single server can be used to cover multiple stores if server capacity exists.

Depending upon the network media and handheld platform support, various protocols between the client and the server can be engaged. Without introducing limitations the best approach currently is SOA using web services. The advantage of using web services are: 1) It is platform independent. 2) It is service independent and 3) Uses well-known ports (HTTP/HTTPs) 4) It is Secure. But the downside of this is the platform support. Not many handheld devices are having web service support at present. A second option is HTTP. HTTP based server is easy to implement, maintain and extend. Most of all it is secure and supported on most of the handheld devices. A third option is to use plain sockets. Sockets are the best choice for proprietary systems. However sockets does not have any built-in data security options. Separate security protocols have to be established out side the existing socket protocols to use this option. The last option is RFCOMM (Bluetooth). This is ideal for typical single store based systems. Bluetooth is fast, has built-in discovery mechanism, inexpensive and most of all it is supported by many handheld devices.

Session handling is another technical challenge. Session can be maintained by the client, server or by both. Without limitation the former has been chosen for this explanation. Client maintained session is efficient and easy to implement. It also reduces the load on the server. Shopping process is relatively slow so even slower handheld devices will be able to manage sessions. Typically in the second case where session is maintained by the server, the server can trace or revoke a client if needed.

Method for entering item code to the client program is not in the scope of this disclosure. However the typical and preferred method is to use camera based barcode reading where ever possible. Customer can also enter the code manually. It is slow, but faster than waiting in the checkout lane. If a barcode scanner is available this will be another alternate method of entry for the item code into the system.

EzCheckout server is necessarily designed as a stabile and secure server. Server has an application program capable of hosting a set of services. It also has a set of database tables for storing configuration and session tracking information. Choice of database is totally up to the deployment. The EzCheckout Server may announce its presence by broadcasting an “announcement” packet over a datagram port. The announcement packet contains only the basic information needed to connect to it. The server will use an authorized CA certificate as its identity while communicating with clients to ensure privacy and security. The EzCheckout server can be hosted over a popular HTTP server like apache or IIS or it can be a custom written application hosting required services.

The EzCheckout system described here to hence provide the customer with a method of fast and secure shopping using his or her personal hand held device. There are no waiting or delay due to long check out lines and lack of check out stations. For the store on the other hand the EzCheckout provides the advantages of cost by reducing the equipment and maintenance cost of checkout stations. The shopping method described also allows reduction in manpower to man the check out stations. The store will also be able to use the prime space saved by reducing the check out lines for storage and displays of products. The use of personal handheld for shopping enable the store to track individual personal preferences of consumer as individuals and groups to tailor the marketing and sales efforts to specific groups. There is also the advantage of being able to provide at the point of sale coupons and information on alternate products on sale to the consumer.

Since the consumer keeps the personal and financial information necessary on his hand held and not stored on store servers, the liability of personal information loss is reduced for the store. The loss of stored personal data leading to identity theft of users is becoming a major concern which is reduced by use of this shopping method.

What is claimed is:

1. A system (EzCheckout) that uses wireless enabled handheld devices to make checkout process in retail stores fast and efficient.

2. The system using wireless enabled hand held devices in claim 1, where in, the hand held devices are customer's cell phones.

3. The system using wireless enabled hand held devices in claim 1, where in, the hand held devices are customer owned PDAs.

4. The system using wireless enabled hand held devices in claim 1, where in, the hand held devices are used as client side hardware.

5. The system using wireless enabled hand held devices in claim 1, where in, the use of hand held devices act as a checkout counter for every customer to make his shopping faster.

6. A system capable of allowing individual consumers to complete shopping process from start to finish, that is, selection of items to completion of payment, comprising:
A hand held device that is wireless enabled;
A host server computer;
A wireless network link connecting the handheld device to the host server;
A standard store server computer connected to store data bases;
A secure com.link between the host server computer and standard store server computer;
An external link from the store server computer for payment processing.

7. The system capable of allowing individual consumers to complete shopping process from start to finish in claim 5, where in, the wireless network link connecting the handheld device to the host server is a secure link during the pre-payment shopping process.

8. The system capable of allowing individual consumers to complete shopping process from start to finish in claim 6, where in, the wireless network link connecting the handheld device to the host server is a super-secure link during payment processing.

9. The system capable of allowing individual consumers to complete shopping process from start to finish in claim 6, where in, the wireless network connecting the handheld to the host server use of Bluetooth.

10. The system capable of allowing individual consumers to complete shopping process from start to finish in claim 6, where in, the wireless network connecting the handheld to the host server use Wi-fi.

11. The system capable of allowing individual consumers to complete shopping process from start to finish in claim 6, where in, the wireless network connecting the handheld to the host server use GPRS.

12. The system using GPRS in claim 11, where in, the host server computer is located outside the store premises.

13. The system capable of allowing individual consumers to complete shopping process from start to finish in claim 6, where in, the host server computer is located in the store premises.

14. A method for making shopping in retail stores faster, efficient and easier for the consumer and cheaper, more economical with lower liability for the store by use of personal wireless enabled handheld devices.

15. The method for making shopping faster, efficient and easier for consumer and cheaper and more economical for the store in claim 14, where in, the handheld device form a dedicated check out line for the consumer.

16. The method for making shopping faster efficient and easier for consumer in claim 14, where in, the shopping is made easier and more efficient by eliminating wait times in check out lines by use of the handheld device.

17. The method for making shopping cheaper and more economical with lower liability for the store in claim 14, where in, cost reduction is achieved by elimination of checkout lines with associated reduction in cost of equipment, manpower and maintenance expenses.

18. The method for making shopping cheaper and more economical with lower liability for the store in claim 14, where in, the liability of the store is reduced by eliminating storage of financial and personal information of consumers on store servers.

19. The method for making shopping faster efficient and easier for consumer and cheaper and more economical for the store in claim 14, where in, the store is able to collect individual personal preference data regarding consumers as individuals and groups, for improved marketing and sales of products and services.

20. The method for making shopping faster efficient and easier for consumer and cheaper and more economical for the store in claim 14, where in, the store is able to provide the consumer with coupons and promotional information on alternate products at point of sale to improve customer shopping efficiency and the store profitability.
